(19) United States
(12) Patent Application Publication
(10) Pub. No.: US 2011/0005250 A1
(43) Pub. Date: Jan. 13, 2011

(54) Switching pressure regulator

(76) Inventor: Alfred F. Perz, Covina, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 12/657,182

(22) Filed: Jan. 16, 2010

Related U.S. Application Data
(60) Provisional application No. 61/270,540, filed on Jul. 9, 2009.

(51) Int. Cl. F25B 41/04; F16K 31/02

(52) U.S. Cl. 62/222; 137/487.5

(57) ABSTRACT

A system for converting gas flowing at variable flow rates and pressure to gas flow at a load dependent flow rate and a regulated pressure. A valve member operable in only two stable states (fully open and closed) by valve actuation means, said valve actuation means being interposed between an input manifold adapted to carry volumes of gas flow at variable flow rates and pressure and an output manifold adapted to carry gas flow at a predetermined constant pressure; a reservoir/accumulator in open connection to said output manifold for temporary storage of portions of said gas flowing through said output manifold; pressure sensing means for monitoring the pressure of the gas flow through said output manifold; and electronic processing means connected to said gas pressure sensing means for activating said valve actuation means in one of its two bi-stable states, depending upon the gas pressure sensed in said output manifold.

### CROSS-REFERENCE TO RELATED APPLICATIONS

This application takes priority from provisional application Ser. No. 61/270,540 filed on Jul. 9, 2009.

### BACKGROUND OF THE INVENTION

1. Field of the Invention

The present invention relates generally to gas flow-regulation systems and more specifically to a system which efficiently converts a high, and varying, pneumatic pressure flow to a lower and constant pressure flow under varying load conditions.

2. Background Art

Controlling and regulating pneumatic pressure is widely used in industry. Vast quantities of regulated air pressure are consumed in the factory environment, including use of power air tools. Air tools are typically smaller and lighter than their electrical counterparts and are inherently safer, i.e. no chance of electrocution. But a significant disadvantage of an air system is the cost of generating the regulated air supply. The principal feature of the Switching Pressure Regulator is its employment to lower the cost of generating regulated air. Another application is use in refrigeration systems wherein the Switching Pressure Regulator is employed as the expansion valve, the key element thereof, thereby lowering the cost of operation because of the efficiency recognized from such an arrangement.

Publication No. US 2002/0062823, “Gas Injection System, Particularly of Methane, for Internal Combustion Engines, and Pressure Regulating Valve Comprised in Said System,” issued as U.S. Pat. No. 6,578,560 on Jun. 17, 2003. The stated purpose of the system is to regulate the gas pressure in the distributing (output) manifold. The system includes a distributing (output) manifold, a reservoir where pressurized gas is accumulated, and a pressure regulating valve interposed between the reservoir and the distributing manifold. The regulating means comprise an electromagnetic actuator controlling a pressure regulating valve, and a pressure sensor in the output/distributing manifold suitable for sending an electrical signal indicative of said pressure to an electronic control unit. An important characteristic of the invention is that said control unit is set up to control a periodical switching of the pressure regulating valve between such closed and open conditions at a constant frequency.

Similarly, Pub. No. 2005/0241624, now U.S. Pat. No. 7,036,491 issued May 6, 2006, shows a distribution manifold, a reservoir, and a pressure reducing valve arranged between the reservoir and the distribution manifold, the purpose of said valve being to bring the gas to a suitable value. The pressure reducing valve is dependent upon the pilot pressure signal sent to it by a pilot solenoid valve controlled by an electronic control unit according to a signal issued by a sensor in the distribution manifold.

Publication 2008/0135019, “Electronic Pressure Reducer or Regulator Unit for Feeding Gas, Particularly Methane or Hydrogen to an Internal Combustion Engine, and Gas feeding System Including This Unit,” discloses a pressure reducing valve and a modulating solenoid valve working together within an electronic pressure regulating unit for use with the gas feed system of Pub. No. 2005/0241624 supra. It is noted that the pressure reducing valve illustrated is described as having a spring of high flexibility and low preloading, the sole function of which is keeping the ball-type open/close element in position.

These systems are for use on fuel delivery systems for internal combustion engines. They do not utilize the unique method of efficiency enhancement of the Switching Pressure Regulator. The fuel flow rates of most internal combustion engines are relatively small and, therefore, the cost savings realized from incorporation of a more efficient regulator would also be small.

While the above-described references disclose low volume gas flow systems for internal combustion engines, U.S. Pat. Nos. 4,362,027; 3,914,952; 4,848,099; and 5,131,237 relate to control systems and components for refrigeration systems.

U.S. Pat. No. 3,914,952 “Valve Control Means and Refrigerator Systems Therefor,” the control of which is linear, and U.S. Pat. No. 4,362,027 “Refrigeration Control System for Modulating Electrically-Operated Expansion Valves” disclose electrically operated expansion valve the open and closing of which is regulated by condition-responsive (i.e., temperature) sensors. U.S. Pat. No. 4,848,099, “Adaptive Refrigerant Control Algorithm” discloses a refrigeration system including an electronically controlled expansion valve working together with an accumulator to maintain a set point superheat valve. U.S. Pat. No. 5,131,237, “Control Arrangement For A Refrigeration Apparatus” discloses a refrigeration system including a plurality of temperature sensor activated thermostatic switch units having on and off valves and which function to operate an electromagnetic valve which controls the refrigerant (gas flow) admitted to the evaporator.

It is, therefore, an object of the present invention to provide significantly higher efficiency in the operation of gas flow control systems for converting high, varying, pressure flow to lower constant pressure flow under varying load conditions; and

It is another object of the present invention to provide improved line and load regulation in flow control systems of the type described; and

It is still another object of the present invention to provide capability of remote control and incorporation of means for customizing the system to accommodate individual requirements.

### SUMMARY OF THE INVENTION

The present invention comprises a system for converting gas flowing at variable flow rates and pressure to gas flow at a constant and regulated pressure. This Switching Pressure Regulator System comprises: A valve member operable in only two stable states (fully open and closed) by valve actuation means, said valve actuation means being interposed between an input manifold adapted to carry gas flow at variable flow rates and pressure and an output manifold adapted to carry gas flow at a predetermined pressure; a reservoir/accumulator in open connection to said output manifold for temporary storage of portions of said gas flowing through said output manifold; pressure sensing means for monitoring the pressure of the gas flow through said output manifold; and electronic processing means connected to said gas pressure sensing means for activating said valve actuation means in one of its two bi-stable states, depending upon the gas pressure sensed in said output manifold.

In operation, the pressure sensor monitors the regulated output pressure, and generates an electrical signal proportional to that pressure, the signal being sent to the processing electronics. If the output pressure is less than the desired output pressure, a signal is sent to the valve actuator commanding it to open. If the output pressure is equal to or greater than the desired pressure, a signal is sent to the valve actuator commanding it to close. The logic in the processing electronics operates solely upon measuring the output pressure and determining regulator response by comparing it to set upper and lower threshold limits as will be explained hereinafter.

An inherent property of the Switching Pressure Regulator is that the output pressure is not constant but varies in a cyclical nature, the amplitude and frequency being determined by regulator design and system requirements. An alternate means of generating the valve control signal is by pulse width modulation (PWM), that is, to apply an open valve control signal at a given frequency and vary the signal duration to maintain a constant output pressure.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a schematic diagram of a conventional pressure regulator;

FIG. 2 is a schematic diagram of the Switching Pressure Regulator of the present invention;

FIG. 3 is a schematic diagram of output pressure versus time in operation of the present invention;

FIG. 4 is a schematic diagram illustrating the operation of Pulse Width Modulation to effect pressure regulation in operation of the present invention;

FIG. 5 is a schematic diagram of an experimental configuration to ascertain Switching Pressure Regulator Efficiency; and

FIG. 6 is a diagram of the Switching Pressure Regulator Used as an Expansion Valve.

### DESCRIPTION OF THE PREFERRED EMBODIMENT

To best understand the advantages of the subject Switching Pressure Regulator, a brief discussion of a conventional pressure regulator is beneficial. As used herein, a “regulator” is defined as a device which converts a high, and possibly varying, pneumatic pressure to a lower and constant pressure. The regulator's function is to maintain this constant low pressure under varying load conditions. “Load” is defined herein as the flow of gas at the lower pressure which may be conveniently measured in ft³/min.

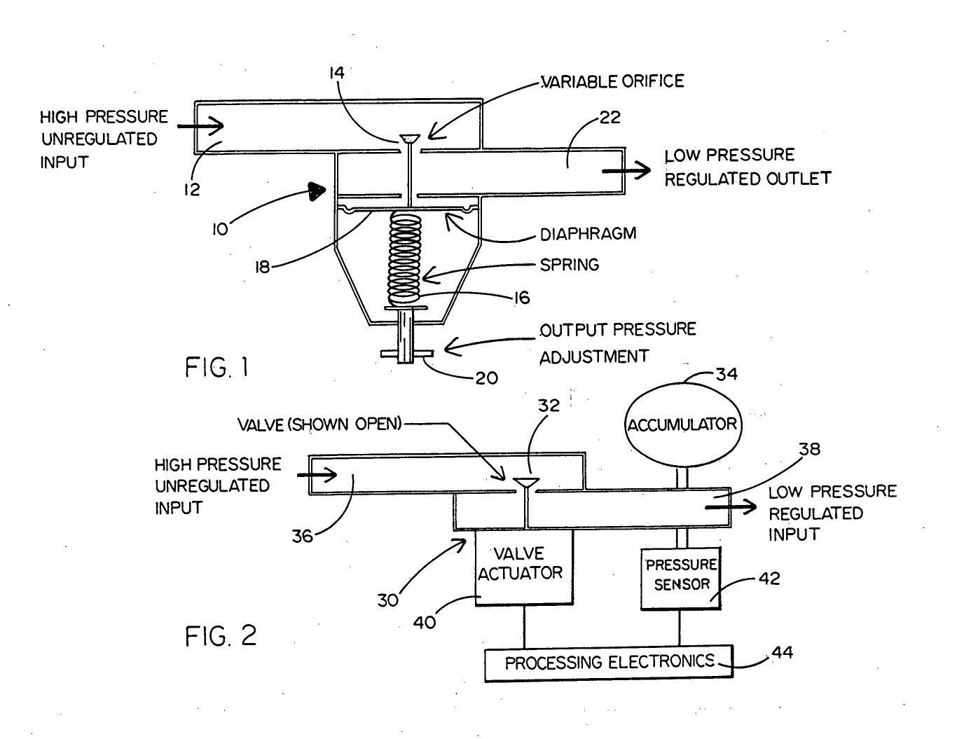

A pictorial representation of a conventional regulator is shown in FIG. 1. In order to perform this task the conventional regulator 10 passes the gas flow from the input manifold 12 through an orifice 14 of varying size. A means is provided to dynamically vary the orifice size to maintain a constant output pressure. Prior to the application of pressure, the spring 16 on the lower portion of the diaphragm 18 pushes the diaphragm up thus opening the orifice 14. Upon application of input pressure, gas flows through the open orifice 14 to the load through the output manifold 22. The output pressure also applies a downward force on the diaphragm 18, counter to the force of the spring 16. This downward force acts in a direction to close the orifice. When the output pressure rises to the desired value, the forces on both sides of the diaphragm 18 will be balanced, thus maintaining the desired output pressure. As the output load is increased, the increased flow through the orifice 14 will cause a greater pressure drop across it causing the output pressure to decrease. This decreased pressure will apply a decreased force on the diaphragm causing the spring 16 to open the orifice thus causing an increased output pressure and restoring the pressure balance across the diaphragm 18. Should the output load decrease, a similar action takes place, again maintaining the desired output pressure. Means 20 for adjusting the output pressure are also provided.

A block diagram representation of the Switching Pressure Regulator is shown in FIG. 2. The operation of the Switching Pressure Regulator 30 of the present invention is entirely different than that of a linear regulator. It is noted that control valve 32 shown is not a variable valve. It is either fully open or fully closed. The valve actuator 40 is a device that either opens or closes the control valve 32.

A pressure sensor 42 monitors the regulated output pressure, and generates an electrical signal proportional to that pressure. This signal is sent to processing electronics 44. As explained in Table 3, hereinafter, the electronics used in a particular Switching Pressure Regulator are application dependent, a basic system requiring only simple discrete logic or an Application Specific Integrated Circuit, while a more complex system would utilize a microprocessor or microcontroller. If the output pressure is less than the desired output pressure, a signal is sent to the valve actuator 40 commanding it to open. If the output pressure is equal to or greater than the desired pressure, a signal is sent to the valve actuator 40 commanding it to close.

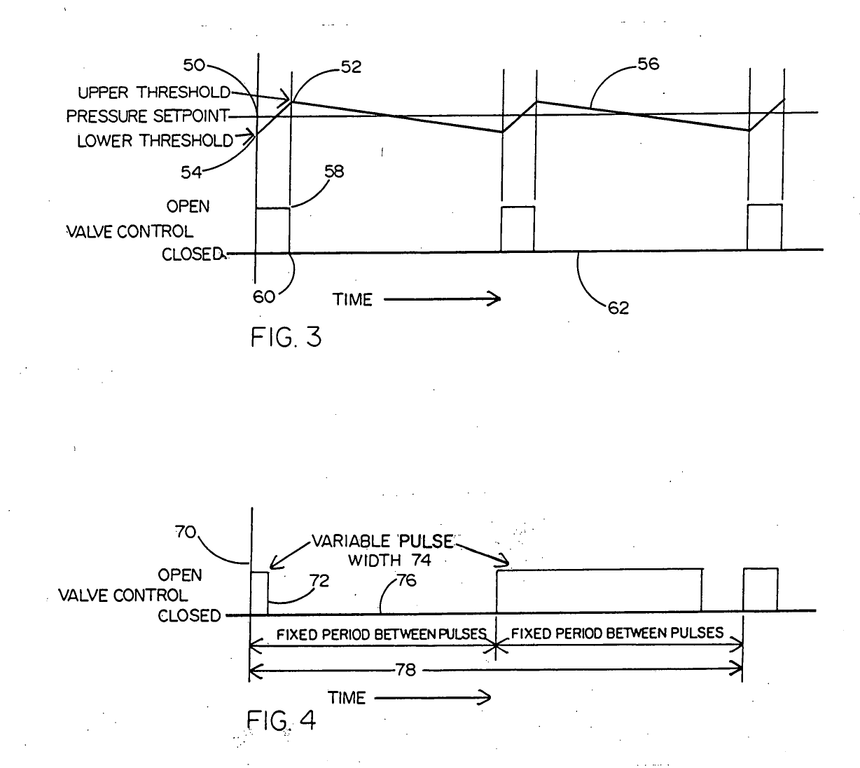

As seen in FIG. 3, there must always be a finite pressure difference between the upper and lower threshold pressures. This difference provides a hysteresis, so that the control valve 32 will not chatter. An inherent property of the Switching Pressure Regulator 30 is that the output pressure 56 is not constant. It varies in a cyclical nature as shown in FIG. 3, set against time 62 where the upper threshold 52 is seen to be set above the pressure setpoint 50 and the lower threshold 54 is set below. The output pressure varies from the lower threshold 54 as the valve 32 (see FIG. 2) is open 58 to the upper threshold 52 causing the valve control to move to the closed position 60, as plotted against time 62. The amplitude and frequency of this ripple are determined by regulator design and system requirements. The purpose of the accumulator 34 is to serve as a low pass filter and remove pressure spikes. The size of the accumulator 34 is dictated by overall system requirements. In the above scheme the logic in the processing electronics 44 operates solely upon measuring the output pressure and determining regulator response by comparing it to the set upper and lower threshold limits.

An alternative for generating the valve control signal is to apply an open valve control signal at a given frequency and vary the signal duration to maintain a constant output pressure. This is known as a Pulse Width Modulation as seen in FIG. 4 wherein the valve control is in the open position 70 when actuated by a valve control signal in the form of a pulse of variable width 74, the valve 32 reverting to the closed position 72 at the end of pulse 74, a fixed period 76 of time 78 elapsing between pulses.

### Implementation of the Switching Pressure Regulator

FIG. 2 shows the subassemblies that may be used to implement a Switching Pressure Regulator 30. The valve 32/valve actuator subassembly 40, comprise the heart of the regulator 30. The salient features are shown in TABLE 1.

TABLE 1
Characteristics Of The Valve/Valve Actuator

| Parameter | Specification | Comments |
|---|---|---|
| Valve States | Fully Open or Closed | Linear Operation Not |
| | | Required |
| Material | Compatible with system | |
| | working fluid and | |
| | pressure | |
| Configuration | Low flow resistance | Possible small leakage |
| | when open | allowed when closed. |
| | | System dependent |
| Activation time | Fast | System dependent |
| Deactivation time | Fast | System dependent |
| Coil Voltage | Electronics require DC | System Dependent |

The pressure sensor is used to measure output pressure and apply its output signal to the processing electronics. The relevant features of the pressure sensor are shown in TABLE 2.

TABLE 2
Characteristics Of The Pressure Transducer

| Parameter | Specification | Comments |
|---|---|---|
| Material/diaphragm | Compatible with | |
| | system working fluid | |
| | and pressure | |
| Configuration | System dependent | |
| Response time | Fast | System dependent. In |
| | | line with valve |
| | | activation/deactivation |
| | | time |
| Voltage | Typically DC | System Dependent |

The processing electronics receive data from the pressure sensor and generate the signals to control the valve/valve actuator assembly. TABLE 3 lists the pertinent characteristics for the processing electronics assembly.

TABLE 3
Characteristics Of The Processing Electronics

| Regulator Type | Specification | Comments |
|---|---|---|
| Basic | Simple discrete logic, | |
| | ASIC | |
| Complex | Microcontroller with | Functions such as |
| | suitable programming | remote control, remote |
| | | sensing, etc. may be |
| | | easily incorporated |

Another component of the regulator is an accumulator 34. The characteristics of the accumulator are shown in TABLE 4.

TABLE 4
Characteristics Of The Accumulator

| Parameter | Specification | Comments |
|---|---|---|
| Material | Compatible with system | |
| | working fluid and | |
| | pressure | |
| Size (volumetric capacity) | Dependent upon system | |

The primary differences between a conventional regulator and the Switching Pressure Regulator are shown in TABLE 5.

TABLE 5
Comparison Between a Conventional Regulator and the Switching
Pressure Regulator

| | Conventional | Switching Pressure |
|---|---|---|
| Parameter | Regulator | Regulator |
| Regulation via | Variable Orifice | On/Off valve |
| Reference Pressure | Spring | Electronic measurement |
| Line regulation | Less accurate | More accurate |
| Load regulation | Less Accurate | More accurate |
| Remote monitoring | No | Yes |
| Remote Control | No | Yes |
| Efficiency | Low | High |
| Custom requirements | Difficult | Easy |

A major feature of the Switching Pressure Regulator that enhances its desirability is the control valve. Being either on or off instead of variable provides a system that is considerably more efficient.

In either system the overall efficiency of the regulator is a function of the energy dissipated in the control element, (valve). The energy dissipated is:

E=f(P×F)

### Where

E=energy dissipated

f( )=a function of

P=Pressure drop across the valve

F=Flow rate through the valve

In a conventional system, the magnitude of flow and pressure are real quantities determined by system dynamics. In a switching system the energy dissipated is calculated by considering the system when the control valve is open and when it is closed. During the portion of the cycle when the valve is open there is a large flow rate through the valve but a very small pressure drop across it. The energy dissipated will be very small. When the valve is closed the pressure drop across the valve will be high, but the flow rate, and the resulting energy dissipated, will be zero. The total energy dissipated, the sum of both above conditions, will be small.

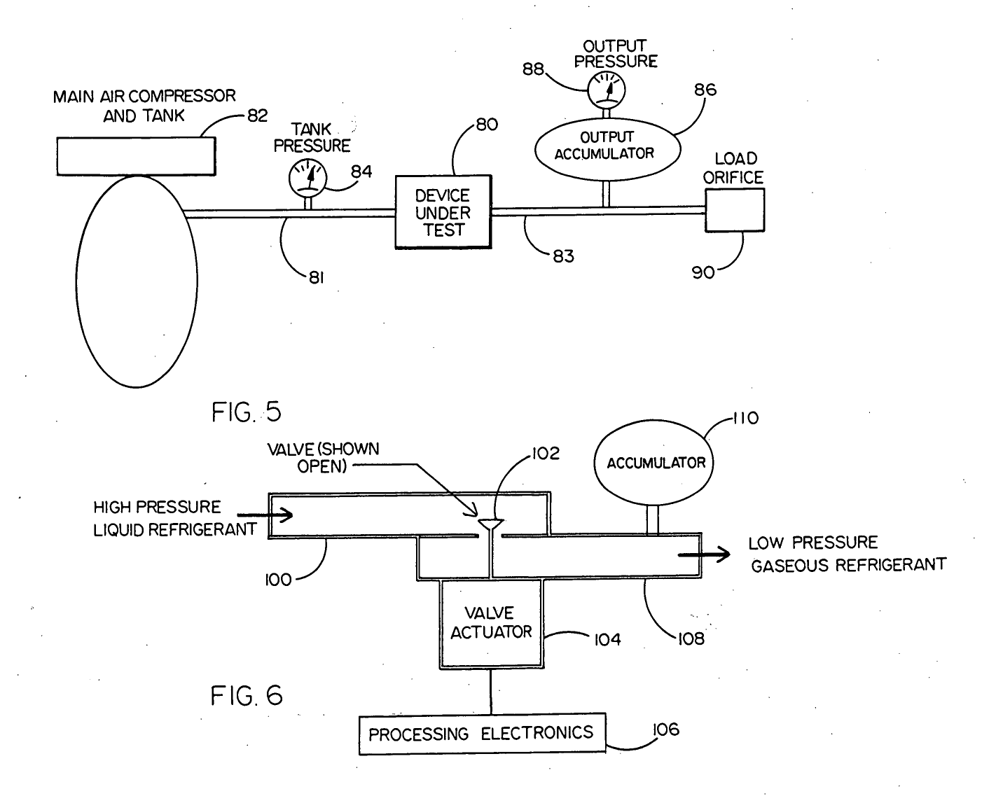

The primary reason for the development of the Switching Pressure Regulator is increased efficiency. An experiment was performed to validate this assertion. A setup of this configuration is shown in FIG. 5. An air compressor and tank 82 connects to a device under test 80 via an input line 81 monitored by a tank pressure gage 84. The device under test 80 connects via an output line 83 to the load orifice 90 and an output accumulator 86, the pressure in the accumulator being measured by an output pressure gage 88. Using a load orifice 90 consisting of a 1/32 in. diameter hole and an output pressure of 25 Lb/in² the air compressor 82 was run for 1 hour using a conventional regulator as the device under test 80 and then 1 hour using the Switching Pressure Regulator as the device under test. The energy consumed was measured during both time intervals. From this test it was observed that the Switching Pressure Regulator consumed 38% less energy than the conventional regulator.

### Switching Pressure Regulator Used as an Expansion Valve

A key element in a refrigeration system is the expansion valve. The basic expansion valve is nothing more than a fixed orifice through which refrigerant flows. FIG. 6 shows this configuration in which the system is operated using pulse width modulation as shown in FIG. 4, although it is within the scope of this invention for the processing electronics 106 to be programmed to generate other types of modulation signals to operate the system. The period between pulses and the pulse width is defined during the refrigeration system design. The valve 102 is energized by a valve actuator 104 in response to a signal from the processing electronics 106. High-pressure liquid refrigerant, compressed by a compressor and cooled by a condenser coil (not shown), is allowed to flow from the input manifold 100 through the expansion valve 102. The output of the expansion valve 102 into the output manifold 108 and the accumulator 110, is a cool low-pressure gas, which has, been expanded through the expansion valve 102. The cooled gas then flows through an evaporator, which cools the air in its environment. The operation of a normal expansion valve 102 is identical to that of a conventional regulator, except that the orifice size is fixed. This expansion valve, when replaced by the Switching Pressure Regulator, or a subset thereof, performs an identical function, except with decreased energy losses. The benefit of this is that two identical air conditioners, one with a conventional expansion valve, and the other with a Switching Pressure Regulator, would have like cooling capacities, but the one utilizing the Switching Pressure Regulator would require less energy input to operate.

The concept of controlling and regulating pneumatic pressure is widely used in industry. The Switching Pressure Regulator is an efficient means of accomplishing this task. Two diverse uses of the Switching Pressure Regulator are for pressure regulation of pneumatic air supply in a factory environment and in refrigeration systems.

Vast quantities of regulated air pressure are normally employed in the factory environment. A significant quantity of regulated air is used to power air tools. Air tools are typically small and lighter than their electrical counterparts plus they are inherently safer, i.e., no chance of electrocution. A significant disadvantage of an air system is the cost of generating the regulated air supply. To generate a horsepower of air is many times more expensive than generating a horsepower of electricity. The main feature of the Switching Pressure Regulator is to lower the cost of generating regulated air.

The basic refrigeration expansion consists of a fixed orifice. The input line of the orifice contains high-pressure liquid refrigerant, while the output side is comprised of gaseous refrigerant. FIG. 6 shows a candidate configuration for an expansion valve to be used in such a system.

This valve can be replaced by a subset of the Switching Pressure Regulator. All that is required is a valve that is opened and closed at a predetermined rate. The advantage of doing this is that less energy is dissipated across the expansion valve. In this embodiment the valve has no pressure sensor or monitoring electronics. The control electronics are designed to provide a fixed pulse rate of predetermined length to the control valve. The period and duration of the control pulses is determined during the design of the refrigeration system and is embedded in the electronic logic. A more advanced expansion valve could vary the pulse duration or repetition rate to conform to a predetermined algorithm.

The similarities between the Switching Pressure Regulator, when it is configured as a regulator and when it is configured as an expansion valve, are apparent when comparing FIGS. 2 and 6. The basic difference is that a pressure sensor is not normally required in the latter but is needed in a configuration when outlet pressure is to be regulated. Moreover the characteristics of its constituent subassemblies are also similar.

A typical Switching Pressure Regulator will be electronically controlled. It will therefore benefit from the added capability that electronics bestow. With a little additional electronics it is possible to remotely control or monitor the regulator. A Switching Pressure Expansion valve could also include features such as constant output pressure.

Embodiments of the present invention have been shown in the form of the Switching Pressure Regulator and the switching expansion valve. A detailed theory of operation has been presented highlighting the benefits of the Switching Pressure Regulator compared to a conventional pressure regulator. The salient features of the Switching Pressure Regulator include: significantly higher efficiency, resulting in a decrease of cost of operation; improved line and load regulation, capability of remote monitoring; capability of remote control; and ease of incorporation of custom requirements.

While the foregoing written description of the invention enables one of ordinary skill to make and use what is considered presently to be the best mode thereof, those of ordinary skill will understand and appreciate the existence of variations, combinations and equivalents of the specific embodiments, methods and examples herein. The invention should therefore not be limited by the above described embodiments, methods and examples, but by all embodiments and methods within the scope and spirit of the invention as defined by the appended claims and their legal equivalents.

I claim:

1. A switching pressure regulator for connecting a varying pneumatic pressure at an input to a lower substantially constant selected pressure at an output connected to a non-constant load; the regulator comprising:
an electromagnetically-controlled valve connected between said input and said output for selectively permitting and blocking flow therebetween depending on whether said valve is open or closed;
a pressure sensor connected to said output for measuring the pressure at said output;
an electronic device connected to said sensor for comparing said measured pressure to said selected pressure and generating a difference signal therefrom;
a valve actuator connected to said electronic device and to said valve for opening and closing said valve depending upon said difference signal for maintaining said selected output pressure; and
an accumulator connected to said output to effectively filter variations in output pressure by temporarily storing and releasing pressure.

2. The switching pressure regulator recited in claim 1 wherein said difference signal comprises a series of pulses, each such pulse causing said valve to open for the duration of the pulse and to close between pulses.

3. The switching pressure regulator recited in claim 2 wherein said pulses are of fixed duration and occur at a variable repetition rate to regulate output pressure.

4. The switching pressure regulator recited in claim 2 wherein said pulses are of a variable duration and occur at a fixed repetition rate to regulate output pressure.

5. The switching pressure regulator recited in claim 1 further comprising a remotely positioned controller for altering operation of said regulator at a location distant from said regulator.

6. The switching pressure regulator recited in claim 1 further comprising a remotely positioned sensor for monitoring operation of said regulator at a location distant from said regulator.

7. An apparatus for regulating a variable pneumatic input pressure to produce a selected relatively constant pneumatic output pressure; the apparatus comprising:
a controllable valve having two conditions, one condition being fully open and the other being fully closed, said valve being interposed between said input pressure and said output pressure;
a pressure sensor measuring actual output pressure relative to said selected output pressure;
an electronic device generating a signal from the difference of actual pressure measured by said sensor and selected output pressure;
a valve actuator responsive to said electronic device difference signal for opening or closing said valve; and
an accumulator connected to receive flow at said output pressure to reduce variations in said actual output pressure relative to said selected output pressure.

8. The pressure regulator apparatus recited in claim 7 wherein said difference signal comprises a series of pulses, each such pulse causing said valve to open for the duration of the pulse and to close between pulses.

9. The pressure regulator apparatus recited in claim 8 wherein said pulses are of fixed duration and occur at a variable repetition rate to regulate output pressure.

10. The pressure regulator apparatus recited in claim 8 wherein said pulses are of a variable duration and occur at a fixed repetition rate to regulate output pressure.

11. The pressure regulator apparatus recited in claim 7 further comprising a remotely positioned controller for altering operation of said regulator at a location distant from said regulator.

12. The pressure regulator apparatus recited in claim 7 further comprising a remotely positioned sensor for monitoring operation of said regulator at a location distant from said regulator.

13. An expansion valve assembly for use in refrigeration systems; the assembly comprising:
an electromagnetically-operated valve receiving an input of liquid refrigerant and selectively permitting output flow of a gaseous refrigerant;
an electronic device generating a series of pulses for opening said valve during each pulse of said series and closing said valve between said pulses; and
an accumulator connected to temporarily store said gaseous refrigerant.
